(19) United States
(12) Patent Application Publication
(10) Pub. No.: US 2008/0278076 A1
(43) Pub. Date: Nov. 13, 2008

(54) Filter and plasma display apparatus including the same

(76) Inventors: Sang-Yeol Hur, Suwon-si (KR); Jae-Woo Bae, Suwon-si (KR); Dong-Gun Moon, Suwon-si (KR); Jun-Kyu Cha, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/149,324

(22) Filed: Apr. 30, 2008

(30) Foreign Application Priority Data
May 8, 2007 (KR) 10-2007-0044715

(51) Int. Cl. H01J 17/49; G02B 5/22; H01J 9/00

(52) U.S. Cl. 313/582; 359/885; 445/24

(57) ABSTRACT

A filter which provides an excellent lightroom contrast by reducing external light reflection and a display apparatus including the same. The filter may be easily manufactured at low cost. The filter may be formed in a single sheet and may include a base film, a plurality of beads formed of a visible light-transmitting material disposed on a front surface of the base film, and a colored binder layer fixing the beads to the base film.

### BACKGROUND OF THE INVENTION

1. Field of the Invention

The present invention relates to a filter and a display apparatus including the same. More particularly, the present invention relates to a filter which provides excellent lightroom contrast by reducing external light reflection and by improving transmissivity of visible light generated and propagated in a forward direction from the display apparatus, and to a display apparatus including the same.

2. Description of the Related Art

A plasma display apparatus using a plasma display panel (PDP) is a flat display device which displays images using a gas discharge principle, and has excellent display capability in terms of brightness, contrast, after image, and viewing angle. In addition, plasma display apparatuses can be made with very large viewing sizes with relatively thin depth in size as compared to conventional cathode-ray tube (CRT) display devices. Due to these advantages, plasma display apparatuses are regarded as a next-generation large-size flat display apparatus.

In conventional plasma display apparatuses, however, a tempered glass filter is disposed on a front surface of a front substrate of the PDP. Use of the tempered glass filter results in formation of double images and a substantial decrease in lightroom contrast due to reflection of external light. In addition, tempered glass filters are heavy and have high manufacturing costs, and add significantly to the weight and cost of plasma display apparatuses employing them. Accordingly, there is a need to address and solve these drawbacks, disadvantages and problems.

### SUMMARY OF THE INVENTION

Embodiments of the present invention are therefore directed to a filter which substantially overcomes one or more of the problems due to the limitations and disadvantages of the related art. It is therefore a feature of an embodiment of the present invention to provide a filter which imparts excellent lightroom contrast by reducing external light reflection, and a display apparatus including the same. It is therefore another feature of an embodiment of the present invention to provide a filter formed in a single sheet, including a base film, a plurality of beads formed of a visible light-transmitting material, and a binder layer fixing the plurality of beads on a front surface of the base film.

The binder layer may be colored and may be formed of an acryl-based resin that is colored. The transmissivity of visible light that propagates in a forward direction from the filter may be higher than the transmissivity of the visible light propagating in a rearward direction of the filter. A thickness of the binder layer may be may be from about one half of an average diameter of the beads to about an average diameter of the beads.

The beads may have substantially the same diameters. The beads may have a variance of diameters that is about 10% or less with respect to an average diameter of the beads. An average diameter of the beads may be about 0.1 μm to about 100 μm.

The base film may comprise at least one of polyethersulphone, polyacrylate, polyetherimide, polyethyelene napthalate, polyethyelene terepthalate, polyphenylene sulfide, polyallylate, polyimide, polycarbonate, cellulose triacetate, and cellulose acetate propionate. The base film may be colored with a predetermined color. The base film may have a thickness of from about 50 μm to about 500 μm.

The filter may further include an adhesive layer disposed on a rear surface of the base film to fix the filter to a front surface of a display apparatus. The adhesive layer may include at least one thermoplastic, or UV or thermosetting resin compound that is an acryl-based resin, a polyester resin, an epoxy resin, a urethane resin, or a pressure sensitive adhesive. The adhesive layer may include at least one of a copper atom-containing resin, a copper compound or phosphor compound-containing resin, a thio derivative-containing resin, a tungsten-based compound-containing resin, or a cyanine-based compound-containing resin, that absorbs near infrared light. The adhesive layer may also include a coloring agent such as dyes or pigment to correct color, block neon light, or block near infrared light. The coloring agent may be at least one of a cyanine-based, squarylium-based, azomethine-based, xanthene-based, oxonol-based, or azo-based compound.

It is therefore another feature of an embodiment of the present invention to provide a plasma display apparatus, including a plasma display panel which displays an image through gas discharge, a circuit substrate operating the plasma display panel, a chassis supporting the plasma display panel and the circuit substrate, and a filter, the filter including a base film, a plurality of beads formed of a visible light-transmitting material, and a binder layer fixing the plurality of beads on a front surface of the base film, wherein the filter is bonded to a front surface of the plasma display panel. The plasma display apparatus may further include an adhesive layer disposed on a rear surface of the base film to fix the filter to a front surface of the plasma display apparatus. The plasma display apparatus as claimed in claim 19, wherein the adhesive layer includes at least one thermoplastic or UV thermosetting resin compound that is an acryl-based resin, a polyester resin, an epoxy resin, a urethane resin, or a pressure sensitive adhesive (PSA).

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic sectional view of a filter according to an embodiment of the present invention;

FIG. 2 illustrates a graph of front-surface transmissivity and rear-surface transmissivity of the filter of FIG. 1;

FIG. 3 illustrates pathways of reflected external light and internal light propagating in a forward direction from a front of a display apparatus when the filter of FIG. 1 is disposed at the front surface of the display apparatus;

FIG. 4 illustrates an exploded, perspective view of a plasma display apparatus including the filter of FIG. 1; and

FIG. 5 illustrates a cross-sectional view of the plasma display apparatus of FIG. 4, taken along line V-V′.

### DETAILED DESCRIPTION OF THE INVENTION

Korean Patent Application No. 10-2007-0044715, filed on May 8, 2007, in the Korean Intellectual Property Office, and entitled: “Filter and Plasma Display Apparatus Including the Same,” is incorporated by reference herein in its entirety.

Example embodiments of the present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an nth member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B and C together, whereas the expression “either A, B, or C” means one of A alone, B alone, and C alone, and does not mean any of both A and B together; both A and C together; both B and C together; and all three of A, B and C together.

As used herein, the terms “transmissivity” and “transmittance” are used interchangeably and refer to the fraction or amount of incident visible light that may pass through the inventive filter and reach a front surface of a front substrate of a PDP used in a plasma display device.

As used herein, the terms “lightroom contrast” and “bright room contrast” are used interchangeably and refer to the level of contrast of a display device as measured in a well-lit environment or brightly lit room. This is in contrast to a darkroom contrast which refers to the level of contrast of a display device as measured in a darkroom.

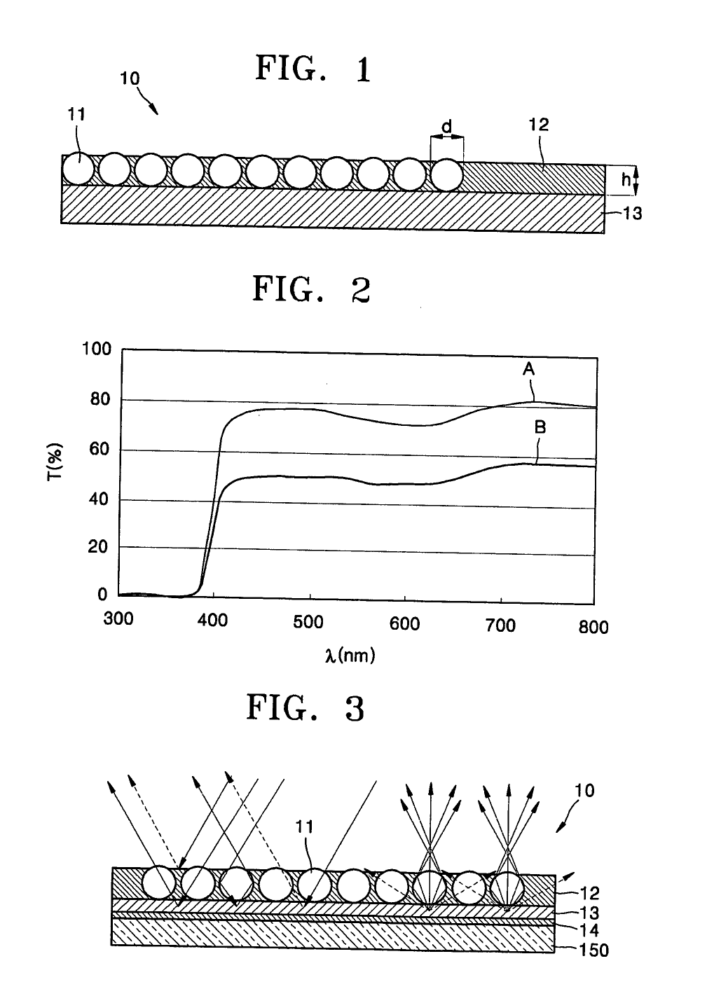

FIG. 1 is a sectional view of a portion of a filter 10 according to an embodiment of the present invention. As illustrated in FIG. 1, the filter 10 may include beads 11, a binder layer 12 that may be colored, and a base film 13.

The beads 11 may be spherical or oval in shape and may be formed of a material that exhibits high transmittance of visible light. The average diameter of the beads 11 may be in the range of about 1 μm to about 100 μm. A plurality of beads 11 is arranged on and bound to the base film 13. The beads 11 may be substantially uniformly distributed on the base film 13.

The binder layer 12 may bind the beads 11 to the base film 13. The binder layer may be colored with a color having low brightness and may absorb at least some of the visible light that is external or ambient to the plasma display device to prevent reflection of any external or ambient visible light from the viewing surface of the plasma display device. At least some visible light may be blocked by reflecting visible light to the outside at the exposed surface of the binder layer 12 or by absorbing visible light into the binder layer 12. Visible light may be actively reflected at the interface between the binder layer 12 and the beads 11.

The binder layer 12 may be formed of an acryl-based resin that may be colored. More specifically, the binder layer 12 may be formed by fixing the base film 13 and the beads 11 together with the acryl-based resin in a liquid state, and then solidifying the acryl-based resin liquid. A colorant may be added to the acryl-based resin in a liquid state before solidifying to make a colored binder layer. The color of the binder layer 12 may be, e.g., black, marine blue, or brown. The binder layer 12 may further include dyes or pigments to control the color and transmissivity of the visible light entering a display apparatus.

The average diameter (d) of the beads 11 may be about the same as or greater than the thickness (h) of the binder layer 12, but no greater than about twice the thickness (h) of the binder layer 12. In other words, the thickness of the binder layer 12 is from about one half of the average diameter of the beads 11 to about an average diameter of the beads 11. The average diameter of the beads 11 may be in the range of about 0.1 μm to about 100 μm. The beads 11 may be spherical so that the diameters of the beads 11 may be substantially the same. Alternatively, the beads 11 may be oval so that the longer diameters of the beads 11 may be substantially the same and the shorter diameters of the beads 11 may be substantially the same. The aberration or variance of diameters of the beads with respect to the average diameter may be about 10% or less.

The filter 10 may be directly bonded to a front surface of the display apparatus using the base film 13. The base film 13 may be formed of a material through which visible light can propagate and may be any transparent material that may be easily and securely attached to glass or plastic relative to the material's interface characteristics. In addition, the base film 13 may be formed of a flexible material to assist in and to simplify the attachment of the base film 13 to the glass or plastic front surface of the display apparatus as well as render it easier to move and transport.

The base film 13 may be formed of polyethersulphone (PES), polyacrylate (PAR), polyetherimide (PEI), polyethyelene napthalate (PEN), polyethyelene terepthalate (PET), polyphenylene sulfide (PPS), polyallylate, polyimide, polycarbonate (PC), cellulose triacetate (TAC), cellulose acetate propionate (CAP), or the like. For example, the base film 13 may be formed of PC, PET, TAC, or PEN.

The base film 13 may be colored with a predetermined color. Accordingly, transmissivity of visible light with respect to the filter 10 can be adjusted by controlling the coloring conditions for the base film 13. For example, when the base film 13 has a dark color, transmissivity of visible light may decrease. In addition, the color of visible light which propagates in a forward direction from the front of a display apparatus including the filter 10 can be controlled. That is, the base film 13 can be colored with a color that is visually pleasing to users, or colored to improve color purity of the display apparatus including the filter 10. Furthermore, the base film 13 may have color patterns corresponding to respective sub pixels of a plasma display panel to which the filter 10 is applied.

The base film 13 may be a flexible panel and may have a thickness of from about 50 μm to about 500 μm, preferably from about 100 μm to about 300 μm. When the base film 13 is too thin, i.e., less than about 50 μm thick, the effects of or capability of preventing the scattering of panel pieces generated when the panel is destroyed or shattered may be decreased. On the other hand, when the base film 13 is too thick, i.e., greater than about 500 μm, the efficiency of the laminating process may be decreased.

The filter 10 may be directly bonded to a front surface of a display panel by an adhesive layer 14. The adhesive layer 14 may be disposed on a rear surface of the base film 13. To decrease a double image phenomenon, the difference in refraction rates of the adhesive layer 14 and a material that forms a front surface of the display apparatus may be adjusted to a predetermined value, such as 1.0% or less.

The adhesive layer 14 may include a thermoplastic, or UV or thermosetting resin. For example, the adhesive layer 14 may include a compound selected from an acryl-based resin, a polyester resin, an epoxy resin, a urethane resin, and pressure sensitive adhesive (PSA). The adhesive layer 14 can be formed by, e.g., dip coating, air knife coating, roller coating, wire bar coating, or gravure coating.

The adhesive layer 14 may further include a compound that absorbs near infrared light, such as a copper atom-containing resin, a copper compound or phosphor compound-containing resin, a thio derivative-containing resin, a tungsten-based compound-containing resin, or a cyanine-based compound-containing resin.

The adhesive layer 14 may further include a coloring agent, such as a dye or pigment, to block neon light for color correction. The coloring agent may selectively absorb light in the visible light region having a wavelength of between about 380 nm to about 770 nm (or between about 400 nm to about 700 nm). In particular, when the plasma display panel is discharged, a neon gas acting as a discharge gas generates unnecessary visible light with a wavelength of about 585 nm. As a result, a cyanine-based, squarylium-based, azomethine-based, xanthene-based, oxonol-based, or azo-based compound may be used to absorb the unnecessary visible light. These coloring agents may be included in the adhesive layer 14, e.g., in a dispersed micro particle form.

The filter 10 may be formed as a single sheet so that it can be easily manipulated and used in a display apparatus. The filter 10 may also be formed and cut to a desired size and shape based on the size and shape of the display apparatus.

FIG. 2 is a graph illustrating the performance of a filter according to an embodiment of the present invention. In FIG. 2, the Y-axis represents transmissivity (T)(unit: %), and the X axis-represents wavelength (λ)(unit: nm.)

Referring to FIG. 2, line A represents transmissivity of visible light propagating from a base film formed of PET to a layer that consists of beads and a binder layer; and line B represents transmissivity of visible light propagating from the layer that consists of beads and a binder layer to the base film formed of PET. In a wavelength band of about 380 nm to about 770 nm of visible light, the average transmissivity when visible light propagates from the base film formed of PET to the layer that consists of beads and a colored binder layer is about 23 to 24% higher than the average transmissivity when visible light propagates from the layer that consists of beads and a binder layer to the base film formed of PE. When the beads or the binder layer includes a coloring agent or a transmissivity controlling film, transmissivity itself can be changed but the difference of the average transmissivity at front and rear surfaces of the filter 10 remains constant. The transmissivity can be adjusted by changing the size of beads.

The transmissivity of the filter 10 according to the present invention may be adjusted by varying the particle size of the beads 11 and by varying the amount of coloring agent included in the binder layer 12. In the filter 10 according to the present invention, the transmissivity of visible light that propagates in a forward direction from the filter may be higher than the transmissivity of the visible light propagating in a rearward direction of the filter. Specifically, the difference in transmissivity of visible light propagating in the forward direction and in the rearward direction may be maintained to 10% or more.

FIG. 3 is a drawing illustrating pathways of reflected external light and internal light propagating in a forward direction from the front of a display apparatus when the filter of FIG. 1 is disposed at the front surface of the display apparatus.

As illustrated on the left side of FIG. 3, external light is partially absorbed and partially reflected by the binder layer 12, so that the amount of light propagating in a rearward direction of the filter 10 decreases. In addition, external visible light entering the bead 11 is partially reflected at a front surface of a display apparatus, and the reflected light enters a rear portion of the binder layer 12 and is then adsorbed, so that the amount of light reflected toward the outside is decreased. As a result, the amount of external light reflected at the front surface of the display apparatus can be significantly decreased.

As illustrated on the right side of FIG. 3, visible light generated in the display apparatus, i.e., light that propagates straight or light that is diffused, is reflected at the interface between the beads 11 and the binder layer 12 and then propagated in a forward direction from the front of the filter 10. However, light that is diffused, i.e., light other than the light that propagates straight, in the forward direction from the front of the display apparatus at large angles is mostly absorbed by the binder layer 12, and thus, the amount of the transmitted light is partially decreased.

Therefore, by using the filter 10, transmissivity of internal light is slightly decreased, but the transmissivity and reflection of external light is substantially decreased. Thus, lightroom contrast of a display device employing the filter 10 may be improved.

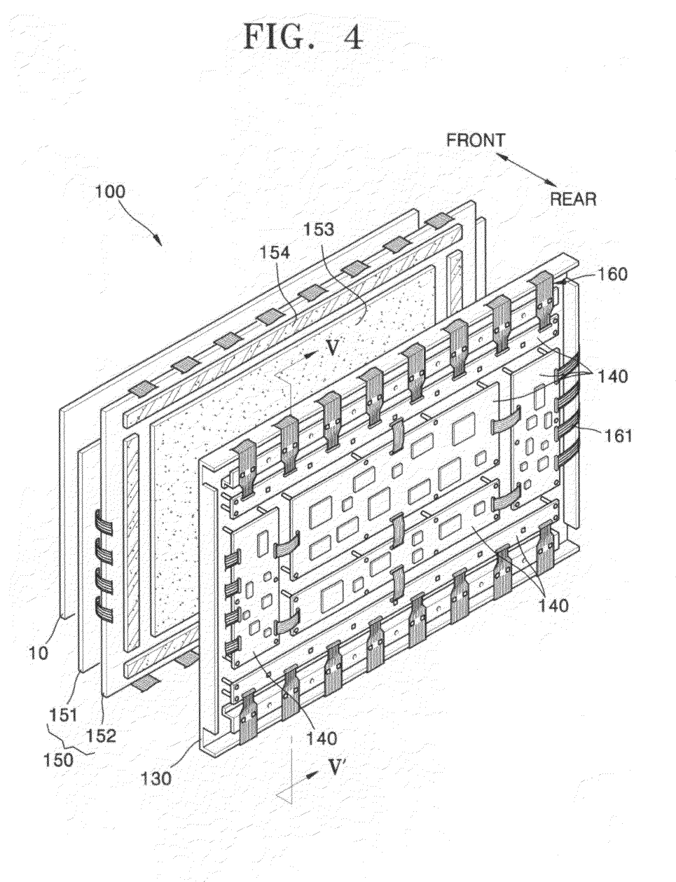

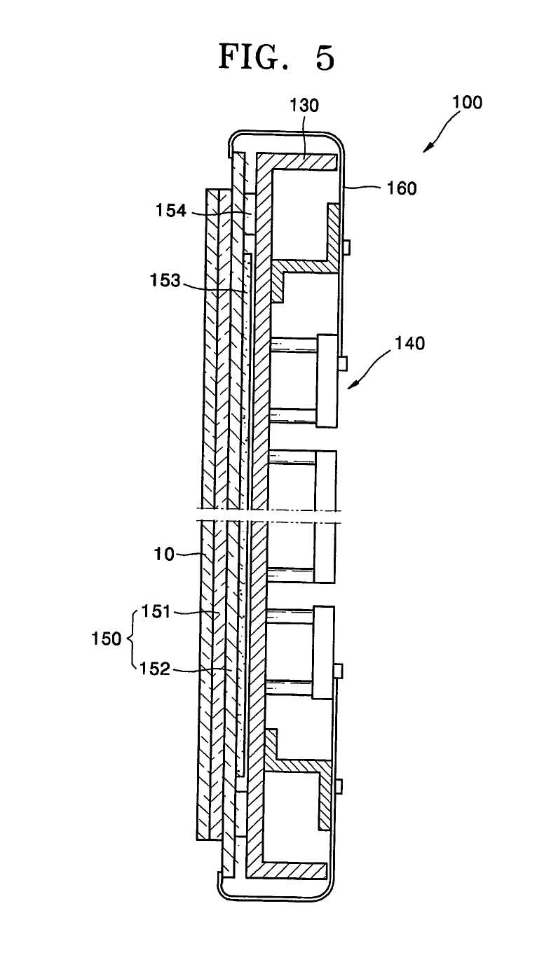

FIG. 4 is a perspective view of a plasma display apparatus 100 including a filter according to an embodiment of the present invention, and FIG. 5 is a cross-sectional view of the plasma display apparatus of FIG. 4, taken along the line V-V′ of FIG. 4.

The plasma display apparatus 100 includes a plasma display panel 150, a chassis 130, and a circuit unit 140. The filter 10 is bound to a front surface of the plasma display panel 150. The plasma display panel 150 may be bonded to the chassis 130 through an adhesive, such as a double-sided tape 154. A thermally conductive member 153 may be interposed between the chassis 130 and the plasma display panel 150 to dissipate heat, which may be generated when the plasma display panel 150 operates, through the chassis 130.

The plasma display panel 150 displays an image through gas discharge, and includes a front panel 151 and a rear panel 152 combined together. The filter 10 can be bound to the front surface of the plasma display panel 150 by the adhesive layer 14 (not shown in FIG. 4).

The plasma display panel 150 including the filter 10 has improved lightroom contrast. In addition, brightness and color may be controlled by adding a coloring agent to the beads 11, by a colored binder layer or by controlling the amount of the coloring agent added. Furthermore, formation of double images may be prevented by directly adhering or binding the filter 10 to a front surface of the plasma display panel 150. The filter 10 may be formed as a single sheet and is, therefore, far more lightweight than conventional tempered glass filters. Moreover, manufacturing costs for the filter 10 are low.

The chassis 130 is disposed at a rear side of the plasma display panel 150 to structurally support the plasma display panel 150. The chassis 130 may be formed of a metal having excellent rigidity, such as aluminum or iron, or plastic.

The thermally conductive member 153 is interposed between the plasma display panel 150 and the chassis 130. The thermally conductive member 153 is surrounded by a plurality of double-sided tapes 154 which fix the plasma display panel 150 and the chassis 130 together.

The circuit unit 140 is disposed on a rear side of the chassis 130, and circuits which operate the plasma display panel 150 are arranged on the circuit unit 140. The circuit unit 140 carries an electrical signal to the plasma display panel 150 by signal carrying means. The signal carrying means can be a flexible printed cable (FPC), a tape carrier package (TCP), a chip on film (COF), or the like. In the current embodiment, FPCs 161 used as the signal carrying means are disposed at left and right sides of the chassis 130, and TCPs 160 used as the signal carrying means are disposed at upper and lower sides of the chassis 130.

Meanwhile, although in the current embodiment, an apparatus including a filter according to an embodiment of the present invention is described as a plasma display apparatus, the filter can be attached to front surfaces of other types of various display apparatuses, e.g., LCD devices, OLED display devices, FED devices, SED devices, etc.

In a filter according to the present invention and, e.g., a plasma display apparatus including the same, lightroom contrast may be substantially improved because of high absorption and reflection blocking effects of external light. In addition, the brightness and color can be controlled by adjusting a coloring agent added to a bead and a binder layer. Furthermore, the filter can be easily manufactured at low cost.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A filter formed in a single sheet, comprising:
a base film;
a plurality of beads formed of a visible light-transmitting material; and
a binder layer fixing the plurality of beads on a front surface of the base film,
wherein the binder layer is colored.

2. The filter as claimed in claim 1, wherein a thickness of the binder layer is from about one half of an average diameter of the beads to about an average diameter of the beads.

3. The filter as claimed in claim 1, wherein the binder layer is formed of an acryl-based resin that is colored.

4. The filter as claimed in claim 1, wherein the color of the colored binder layer is black, marine blue or brown.

5. The filter as claimed in claim 1, wherein the transmissivity of visible light that propagates in a forward direction from the filter is higher than the transmissivity of the visible light propagating in a rearward direction of the filter.

6. The filter as claimed in claim 1, wherein the beads have substantially the same diameters.

7. The filter as claimed in claim 1, wherein the beads have a variance of diameters that is about 10% or less with respect to an average diameter of the beads.

8. The filter as claimed in claim 1, wherein an average diameter of the beads is about 0.1 μm to about 100 μm.

9. The filter as claimed in claim 1, wherein the base film comprises at least one of polyethersulphone, polyacrylate, polyetherimide, polyethyelenen napthalate, polyethyelene terepthalate, polyphenylene sulfide, polyallylate, polyimide, polycarbonate, cellulose triacetate, and cellulose acetate propionate.

10. The filter as claimed in claim 1, wherein the base film is colored with a predetermined color.

11. The filter as claimed in claim 1, wherein the base film has a thickness of about 50 μm to about 500 μm.

12. The filter as claimed in claim 1, further comprising an adhesive layer disposed on a rear surface of the base film to fix the filter to a front surface of a display apparatus.

13. The filter as claimed in claim 12, wherein the adhesive layer includes at least one thermoplastic, or UV or thermosetting resin compound that is an acryl-based resin, a polyester resin, an epoxy resin, a urethane resin, or a pressure sensitive adhesive.

14. The filter as claimed in claim 13, wherein the adhesive layer includes at least one of a copper atom-containing resin, a copper compound or phosphor compound-containing resin, a thio derivative-containing resin, a tungsten-based compound-containing resin, or a cyanine-based compound-containing resin, that absorbs near infrared light.

15. The plasma display apparatus as claimed in claim 13, wherein the adhesive layer includes a coloring agent such as dyes or pigment to correct color, block neon light, or block near infrared light.

16. The plasma display apparatus as claimed in claim 15, wherein the coloring agent is at least one of a cyanine-based, squarylium-based, azomethine-based, xanthene-based, oxonol-based, or azo-based compound.

17. A plasma display apparatus, comprising:
a plasma display panel which displays an image through gas discharge;
a circuit substrate operating the plasma display panel;
a chassis supporting the plasma display panel and the circuit substrate; and
the filter as claimed in claim 1, wherein the filter is fixed to a front surface of the plasma display panel.

18. The plasma display apparatus as claimed in claim 17, further comprising an adhesive layer disposed on a rear surface of the base film to fix the filter to the front surface of the plasma display panel.

19. The plasma display apparatus as claimed in claim 18, wherein the adhesive layer includes at least one thermoplastic, or UV or thermosetting resin compound that is an acryl-based resin, a polyester resin, an epoxy resin, a urethane resin, or a pressure sensitive adhesive.

20. A method of manufacturing a plasma display apparatus, comprising:
providing a plasma display panel which displays an image through gas discharge;
providing a circuit substrate operating the plasma display panel;
providing a chassis supporting the plasma display panel and the circuit substrate; and
providing a filter having a base film, a plurality of beads formed of a visible light-transmitting material, and a binder layer fixing the plurality of beads on a front surface of the base film, wherein a thickness of the binder layer is from about one half of an average diameter of the beads to about an average diameter of the beads,
wherein the filter is fixed to a front surface of the plasma display panel.
